(19) United States
(12) Patent Application Publication
(10) Pub. No.: US 2025/0108453 A1
(43) Pub. Date: Apr. 3, 2025

(54) DEVICES, SYSTEMS, AND METHODS FOR WELDING

(71) Applicant: Sunstone Engineering LLC, Payson, UT (US)

(72) Inventors: Larin Amos DODGEN, Payson, UT (US); David Wayne HOLLOWAY, Payson, UT (US); Thane William KENNEDY, Payson, UT (US); Scott Eugene STUBBS, Payson, UT (US)

(21) Appl. No.: 18/795,958

(22) Filed: Aug. 6, 2024

Related U.S. Application Data
(60) Provisional application No. 63/587,351, filed on Oct. 2, 2023.

(51) Int. Cl. B23K 11/31; B23K 11/06

(52) U.S. Cl. CPC B23K 11/317; B23K 11/06

(57) ABSTRACT

A welding device may include a weld head. A welding device may include a positive welding electrode connected to the weld head. A welding device may include a positive electromagnetic actuator connected to the positive welding electrode. A welding device may include a positive position sensor configured to detect a position of the positive welding electrode. A welding device may include a positive force sensor configured to detect a force applied by the positive welding electrode. A welding device may include a negative welding electrode connected to the weld head. A welding device may include a negative electromagnetic actuator connected to the negative welding electrode. A welding device may include a negative position sensor configured to detect a position of the negative welding electrode. A welding device may include a negative force sensor configured to detect a force applied by the negative welding electrode.

### CROSS-REFERENCE TO RELATED APPLICATIONS

This is a non-provisional patent application of co-pending U.S. Provisional Patent Application Ser. No. 63/587,351 to Larin Amos Dodgen, filed on Oct. 2, 2023, and entitled “DEVICES, SYSTEMS, AND METHODS FOR WELDING,” which is hereby incorporated by reference in its entirety for all intents and purposes by this reference.

### BACKGROUND

Welding is the joining of two materials. Welding of metals often includes heating one or both of the materials to a melting point of the materials. This may cause the two materials to bond, such as by mixing of the two materials and/or bonding of a melted portion of a first material to a solid portion of a second material. Resistance welders pass electricity through two materials to be joined, and the resistance of the welding target causes the welding target to heat to the melting point, thereby forming a weld.

### BRIEF SUMMARY

In some aspects, the techniques described herein relate to a welder. The welder includes: a weld head. The welder includes a positive welding electrode connected to the weld head. A positive electromagnetic actuator is connected to the positive welding electrode. The welder includes a positive position sensor configured to detect a position of the positive welding electrode and a positive force sensor configured to detect a force applied by the positive welding electrode. The welder includes a negative welding electrode connected to the weld head. A negative electromagnetic actuator is connected to the negative welding electrode. The welder includes a negative position sensor configured to detect a position of the negative welding electrode and a negative force sensor configured to detect a force applied by the negative welding electrode.

In some aspects, the techniques described herein relate to a method for welding control. A force and position manager positions, using a plurality of electromagnetic actuators, a positive welding electrode and a negative welding electrode with respect to a welding target. A position monitor measures a positive force and a positive position for the positive welding electrode. The position monitor measures a positive force and a positive position for the negative welding electrode. Based on at least one of a force difference between the electrode force or a position difference, the force and position manager adjusts at least one of a position or a force of the positive welding electrode or the negative welding electrode.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a schematic representation of a welding system, according to at least one embodiment of the present disclosure.

FIG. 2 is a perspective view of a resistance welder, according to at least one embodiment of the present disclosure.

FIG. 3 is a representation of a welding control system, according to at least one embodiment of the present disclosure.

FIG. 4 is a flowchart of a method for welding, according to at least one embodiment of the present disclosure.

FIG. 5 is a schematic representation of a welding system, according to at least one embodiment of the present disclosure.

FIG. 6 is a schematic representation of a computing system, according to at least one embodiment of the present disclosure.

### DETAILED DESCRIPTION

This disclosure generally relates to devices, systems, and methods for a resistance welding device (as used herein, resistance welder or welder). A resistance welding passes an electric current from a positive electrode, through a welding target, and to a negative electrode. Resistance at the welding target may cause the welding target to heat. When the heating exceeds the welding target's melting temperature, then the welding target may melt. The welding target may include two metals to be joined, and when at least one, and possibly both, of the metals of the welding target melt, then the two materials may be joined.

In according with at least one embodiment of the present disclosure, a resistance welder may include a separate electromagnetic actuator for each electrode. Both of the electromagnet actuators may be independently actuatable. This may allow the electrodes to be independently positioned and apply an independent force against the welding target.

The resistance welder may include force and position sensors for each of the electrodes. The force and position sensors may detect the force applied to the welding target and/or any change in position by the electrodes. This may help to improve the control and/or precision of the welder. For example, while performing a weld, the welder may independently actuate the electrodes, including applying a different force to the welding target with each electrode and/or moving each electrode a different amount. This may allow the welder to optimize the welding process. For example, this may allow the welder to balance the forces between the two electrodes, apply different forces to each electrode, perform a weld on an uneven surface, otherwise optimize the welding process, and combinations thereof.

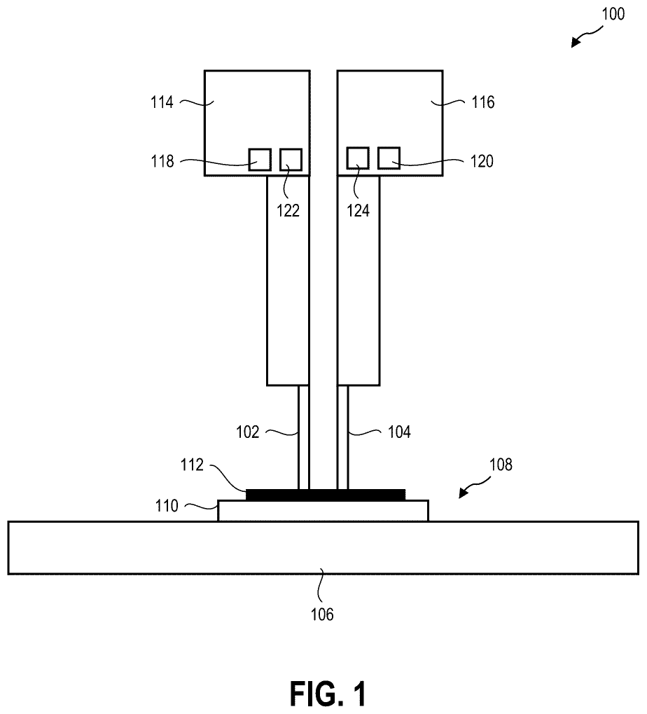

FIG. 1 is a schematic representation of a welding system 100, according to at least one embodiment of the present disclosure. The welding system 100 includes a positive electrode 102 and a negative electrode 104. A slide tray 106 may provide support for a welding target 108. The welding target 108 includes a first material 110 and a second material 112. The first material 110 and the second material 112 may both be conductive materials. For example, the first material 110 and the second material 112 may both be formed from a metallic element. In some embodiments, the first material 110 and the second material 112 may be formed from the same material. In some embodiments, the first material 110 and the second material 112 may be formed from different materials. For example, the first material 110 may be silicon base having a metal pad or other metal securing element, such as the silicon base of a printed circuit board, and the second material 112 may be a material that is to be attached to the silicon base, such as a conductive wire. As may be understood, the first material 110 and the second material 112 may include any combination of materials that may be welded and/or joined through a welding process.

When a current is applied to the positive electrode 102, the current may follow the path of least resistance from the positive electrode 102, through the second material 112, and into the negative electrode 104. In some embodiments, the current may pass at least partially into the first material 110. Resistance in the second material 112 and/or the first material 110 may cause the second material 112 and/or the first material 110 to increase in temperature. The current may be applied until the temperature of the second material 112 and/or the first material 110 reaches or exceeds the melting temperature of the second material 112 and/or the first material 110. This may cause at least one of the second material 112 or the first material 110 to melt. Upon cooling, the melted material may solidify, thereby joining the second material 112 to the first material 110.

As may be seen, the positive electrode 102 and the negative electrode 104 may be located adjacent to each other. In this manner, the welding system 100 may be a gap welder, or a parallel gap welder. A gap welder may be utilized when the welding target 108 is inaccessible from both sides.

In accordance with at least one embodiment of the present disclosure, the welding system 100 may be a microwelding system. Microwelding may be the process of using a welder to generate small welds. For example, microwelding may be used to generate welds that have a weld thickness of less than 5 mm, less than 4 mm, less than 3 mm, less than 2 mm, less than 1 mm, less than 0.1 mm, less than 0.01 mm, or any value therebetween. In some embodiments, the weld thickness may be between 0.007 mm and 5 mm. In some embodiments, the weld thickness may be between 0.1 and 0.2 mm. In some embodiments, the weld thickness may be between 0.01 mm and 0.1 mm.

In accordance with at least one embodiment of the present disclosure, each of the positive electrode 102 and the negative electrode 104 may include an electromagnetic actuator. For example, the positive electrode 102 may include a positive electromagnetic actuator 114 and the negative electrode 104 may include a negative electromagnetic actuator 116. The electromagnetic actuators may position the electrodes with respect to the welding target 108. For example, the positive electromagnetic actuator 114 may position the positive electrode 102 with respect to the welding target 108 and the negative electromagnetic actuator 116 may position the negative electrode 104 with respect to the welding target 108.

The positive electromagnetic actuator 114 may position the positive electrode 102 by moving the positive electrode 102 vertically with respect to the welding target 108. When the positive electrode 102 comes into contact with the second material 112, the positive electromagnetic actuator 114 may apply a force to the second material 112 and the first material 110 through the positive electrode 102. The negative electromagnetic actuator 116 may position the negative electrode 104 by moving the negative electrode 104 vertically with respect to the welding target 108. When the negative electrode 104 comes into contact with the second material 112, the positive electromagnetic actuator 114 may apply a force to the second material 112 and the first material 110 through the negative electrode 104.

In some embodiments, the positive electromagnetic actuator 114 may position the positive electrode 102 independently from the negative electrode 104. For example, the positive electromagnetic actuator 114 may move the positive electrode 102 vertically with respect to the welding target 108 independent of any motion of the negative electrode 104, including at a different rate (e.g., faster, slower), a longer distance, a shorter distance, while the negative electrode 104 is stationary, any other movement, and combinations thereof. The negative electromagnetic actuator 116 may position the negative electrode 104 independently from the positive electrode 102. For example, the negative electromagnetic actuator 116 may move the negative electrode 104 vertically with respect to the welding target 108 independent of any motion of the negative electrode 104, including at a different rate (e.g., faster, slower), a longer distance, a shorter distance, while the positive electrode 102 is stationary, any other movement, and combinations thereof.

In some examples, the positive electromagnetic actuator 114 may apply a positive force to the second material 112 through the positive electrode 102 independent of a negative force applied to the second material 112 through the negative electrode 104. For example, the positive electromagnetic actuator 114 may apply a larger force, a smaller force, apply the force with a different application rate, apply any other different force, and combinations thereof. In some examples, the negative electromagnetic actuator 116 may apply a negative force to the second material 112 through the negative electrode 104 independent of a positive force applied to the second material 112 through the positive electrode 102. For example, the negative electromagnetic actuator 116 may apply a larger force, a smaller force, apply the force with a different application rate, apply any other different force, and combinations thereof.

The positive electromagnetic actuator 114 and the negative electromagnetic actuator 116 may be any type of electromagnetic actuator. For example, the electromagnetic actuators may include one or more solenoids or solenoid motors, one or more valve coil actuators, one or more linear motors, any other type of electromagnetic actuator, and combinations thereof. Utilizing an electromagnetic actuator may help to increase the accuracy and/or precision of the placement of the positive electrode 102 and/or the negative electrode 104. In some embodiments, utilizing an electromagnetic actuator may help to increase the accuracy and/or precision of the force applied to the welding target 108 through the positive electrode 102 and/or the negative electrode 104. As discussed herein, the welding system 100 may be a microwelding system. The increased precision provided by the electromagnetic actuators may help to ensure that the microwelds of the microwelding system may be in the desired location and/or have the desired size. This may help to improve the accuracy and/or precision of welds and/or welding projects performed using the welding system 100.

The welding system 100 may include sensors to detect the force and/or position of the positive electrode 102 and the negative electrode 104. For example, a positive position sensor 118 may detect and/or monitor the position of the positive electrode 102. The positive position sensor 118 may detect and/or monitor the position of the positive electrode 102 with respect to any reference, including the slide tray 106, the first material 110, the second material 112, the positive electromagnetic actuator 114, any other reference, and combinations thereof. For example, a negative position sensor 120 may detect and/or monitor the position of the negative electrode 104. The negative position sensor 120 may detect and/or monitor the position of the negative electrode 104 with respect to any reference, including the slide tray 106, the first material 110, the second material 112, the negative electromagnetic actuator 116, any other reference, and combinations thereof.

A positive force sensor 122 may detect and/or monitor the force applied by the positive electrode 102 to the second material 112 and/or the first material 110. A negative force sensor 124 may detect and/or monitor the force applied by the negative electrode 104 to the second material 112 and/or the first material 110.

Monitoring the force and/or position of the positive electrode 102 and the negative electrode 104 may help to improve the quality of the welds by the welding system 100. For example, the force applied by the electrodes may influence the heat generated by the current passing through the welding target 108. A higher force may increase the generated heat and a lower force may decrease the generated heat. In some examples, a differential force applied by the electrodes may influence the location of the weld nugget in the welding target 108. Controlling the force applied between the positive electrode 102 and/or the negative electrode 104 may help to control the location and/or size of the weld nugget in the welding target 108.

In some embodiments, monitoring the position of the positive electrode 102 and the negative electrode 104 may help to increase the accuracy and/or precision of the positioning of the positive electrode 102 and the negative electrode 104. For example, while arranging the welding target 108 to be welded, the positive electrode 102 and/or the negative electrode 104 may be located at different heights above the welding target 108. Monitoring the position above the welding target 108 may allow the positive electrode 102 and the negative electrode 104 to simultaneously contact the welding target 108. In some embodiments, monitoring the position above the welding target 108 may help to control the relative forces between the positive electrode 102 and the negative electrode 104. For example, if one of the positive electrode 102 or the negative electrode 104 starts closer to the welding target 108, when the positive electrode 102 and the negative electrode 104 are moved closer to the welding target 108, that electrode will engage the welding target 108 first. Continuing to move the electrodes at the same rate to the welding target 108 may cause the electrode first in contact with the welding target 108 to contact the welding target 108 with increased force and/or may prevent the other electrode from contacting the welding target 108. In this manner, the welding system 100 may help to accurately and precisely position the positive electrode 102 and the negative electrode 104 with respect to the welding target 108.

In some embodiments, the position and/or force of the positive electrode 102 and the negative electrode 104 may be monitored during welding activities. While welding, the second material 112 and/or the first material 110 may at least partially melt. Based on the force applied to the electrodes, when the second material 112 and/or the first material 110 at least partially melts, the force applied to the positive electrode 102 and/or the negative electrode 104 may cause the associated electrode to be displaced, pushing into the second material 112 and/or the first material 110. If the electrode is displaced past a displacement threshold, the quality of the weld may be reduced.

In accordance with at least one embodiment of the present disclosure, the welding system 100 may control the force and/or positioning of the positive electrode 102 and the negative electrode 104 during welding. For example, a force and position manager may monitor the force and/or positioning during welding activities. When the force and position manager detects movement of the electrode during welding, the force and position manager may control the force applied to the electrode to prevent the electrode from exceeding the displacement threshold. In some embodiments, the force and position manager may reduce the force applied to the electrode when the electrode reaches the displacement threshold. In some embodiments, the force and position manager may adjust the position of the electrode when the electrode reaches the displacement threshold. This may help to improve the quality of the welds and/or reduce or prevent the formation of bad welds.

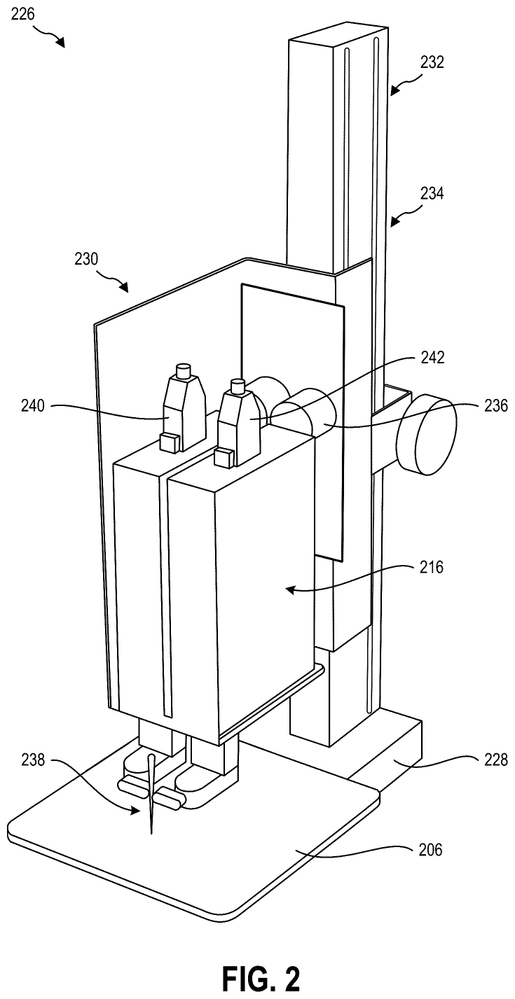

FIG. 2 is a perspective view of a resistance welder 226, according to at least one embodiment of the present disclosure. The resistance welder 226 includes a base 228. A slide tray 206. A welding target may be supported by the slide tray 206. A welder housing 230 may be supported by an upright support 232. The upright support 232 may be connected to the base 228. The welder housing 230 may be connected to the upright support 232 with a positioning system 234. The positioning system 234 may include any positioning mechanism, including a set of gears, a linear motor, a worm gear motor, a hydraulic piston, a pneumatic piston, a manual positioning system, any other type of positioning system, and combinations thereof.

The resistance welder 226 includes a weld head 236. The weld head 236 may provide welding power and control to the electrodes 238 to perform welding activities. The general position of the electrodes 238 with respect to the slide tray 206 (and the welding target located on the slide tray 206) may be controlled by the weld head 236. The fine-tuned position of the electrodes 238 with respect to the slide tray 206 may be controlled by electromagnetic actuators. For example, the position of the positive electrode 238 may be controlled by a positive electromagnetic actuator 214 and the position of the negative electrode 238 may be controlled by a negative electromagnetic actuator 216.

The positive electromagnetic actuator 214 and the negative electromagnetic actuator 216 may be connected to the weld head 236 using weld controller. For example, the positive electromagnetic actuator 214 may be connected to the weld head 236 with a positive weld controller 240 and the negative electromagnetic actuator 216 may be connected to the weld head 236 with a negative weld controller 242. The positive weld controller 240 and the negative weld controller 242 may provide control signals to the weld head 236 based on feedback from force and position sensors configured to detect a force and/or position of the electrodes 238.

In accordance with at least one embodiment of the present disclosure, the force and position sensors may be located at the electromagnetic actuators. Each of the electromagnetic actuators may include an associated force and position sensor. For example, the positive electromagnetic actuator 214 may include, on the positive electrode, a positive force sensor and a positive position sensor. The negative electromagnetic actuator 216 may include, on the negative electrode, a negative force sensor and a negative position sensor. As discussed herein, while performing welding operations, the positive electromagnetic actuator 214 and the negative electromagnetic actuator 216 may monitor the force and position of the electrodes 238. Based on the sensed force and position, the positive weld controller 240 and the negative weld controller 242 may provide welding instructions to the weld head 236. For example, if the force and position sensors of the positive electromagnetic actuator 214 and the negative electromagnetic actuator 216 detect that either the force or position of the electrodes 238 is outside of a threshold, then the positive weld controller 240 and/or the negative weld controller 242 may instruct the weld head 236 to delay welding and/or to change the operation of the resistance welder 226.

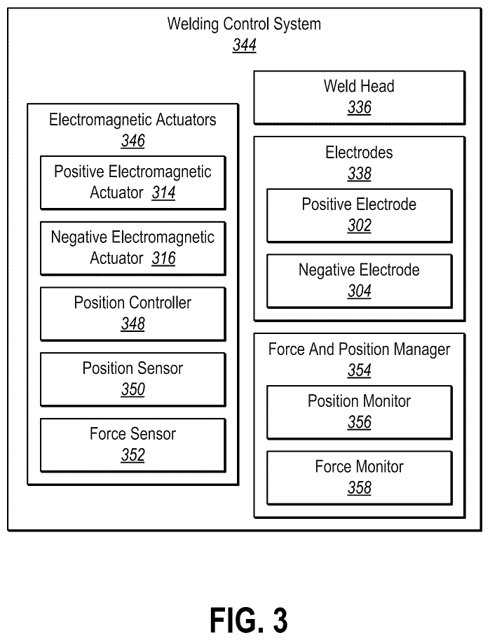

FIG. 3 is a representation of a welding control system 344, according to at least one embodiment of the present disclosure. Each of the components of the welding control system 344 can include software, hardware, or both. For example, the components can include one or more instructions stored on a computer-readable storage medium and executable by processors of one or more computing devices, such as a client device or server device. When executed by the one or more processors, the computer-executable instructions of the welding control system 344 can cause the computing device(s) to perform the methods described herein. Alternatively, the components can include hardware, such as a special-purpose processing device to perform a certain function or group of functions. Alternatively, the components of the welding control system 344 can include a combination of computer-executable instructions and hardware.

Furthermore, the components of the welding control system 344 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The welding control system 344 includes a weld head 336. The weld head 336 may be connected to welding electrodes 338, including a positive electrode 302 and a negative electrode 304. The weld head 336 may supply and control electric current that is transmitted to the welding electrodes 338. For example, the weld head 336 may supply current to the positive electrode 302. The negative electrode 304 may be connected to a ground. When the positive electrode 302 and the negative electrode 304 are placed in contact with a welding contact, the circuit from the weld head 336, to the positive electrode 302, to the negative electrode 304 may be closed. This may heat the welding target until a weld is formed at the welding target.

The position of the welding electrodes 338 may be controlled by electromagnetic actuators 346. The electromagnetic actuators 346 include a positive electromagnetic actuator 314 and a negative electromagnetic actuator 316. Each of the positive electromagnetic actuator 314 and the negative electromagnetic actuator 316 may include a position controller 348. The position controller 348 may control the positive electromagnetic actuator 314 and the negative electromagnetic actuator 316. For example, the position controller 348 may cause the positive electromagnetic actuator 314 and the negative electromagnetic actuator 316 to adjust the position of the electrodes 338 with respect to a welding target.

The electromagnetic actuators 346 may further include position sensors 350 and force sensors 352. For example, each of the positive electromagnetic actuator 314 and the negative electromagnetic actuator 316 may include an associated position sensor 350 and force sensor 352.

A force and position manager 354 may monitor the position sensors 350 and the force sensors 352. For example, the force and position manager 354 may include a position monitor 356 and a force monitor 358. The position monitor 356 may receive position measurements from the position sensors 350 and compare the position measurements to a known location. The known location may include the welding target. In some embodiments, the force and position manager 354 may instruct the position controller 348 to move the electrodes (using the positive electromagnetic actuator 314 and the negative electromagnetic actuator 316) into contact with the welding target. In some embodiments, as discussed herein, the positive electrode 302 and the negative electrode 304 may be located at different distances away from the welding target. The position monitor 356 may identify the distance each of the welding electrodes 338 have to travel and instruct the position controller 348 to move the welding electrodes 338 the associated distances. For example, the welding electrodes 338 may become misaligned, the welding target may have a variable height surface, or the welding electrodes 338 may be different distances from the welding target for any other reason.

The force monitor 358 may monitor the force applied by the welding electrodes 338, as measured by the force sensors 352. The force monitor 358 may compare the applied force to a force threshold. If the applied force to one or both of the welding electrodes 338 is below a minimum force threshold, then the force and position manager 354 may instruct the position controller 348 to increase the applied force on the electrode to be within the threshold range. If the applied force to one or both of the welding electrodes 338 is above a maximum force threshold, then the force and position manager 354 may instruct the position controller 348 to reduce the applied force on the electrode to be within the threshold range.

In some embodiments, the force monitor 358 may identify any differences in applied force between the welding electrodes 338. If the differences are outside of a specified difference, then the force monitor 358 may cause the position controller 348 to adjust the forces on the welding electrodes 338. For example, the welding specification may indicate that the two welding electrodes 338 should apply the same force. The force monitor 358 may identify that the negative electrode 304 is applying a different force than the positive electrode 302. Upon identifying the difference, the force and position manager 354 may instruct the position controller 348 to adjust the applied force on the welding electrodes 338 to equalize the forces. In some examples, the welding specification may indicate that the applied forces are different between the positive electrode 302 and the negative electrode 304, such as with a force ratio or other comparative force metric. The force monitor 358 may identify that the force differential exceeds the specification, and the force and position manager 354 may cause the position controller 348 to adjust the forces applied by the electromagnetic actuators 346 until the force differential is within the specification.

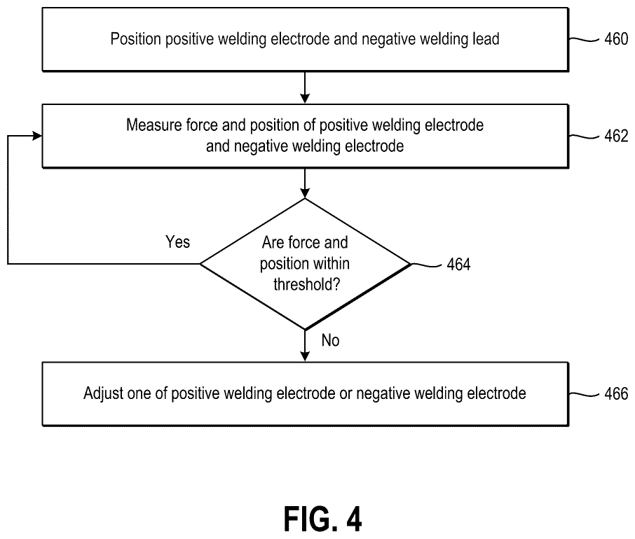

FIG. 4, the corresponding text, and the examples provide a number of different methods, systems, devices, and computer-readable media of the welding control system 344. In addition to the foregoing, one or more embodiments can also be described in terms of flowcharts comprising acts for accomplishing a particular result, as shown in FIG. 4 FIG. 4 may be performed with more or fewer acts. Further, the acts may be performed in differing orders. Additionally, the acts described herein may be repeated or performed in parallel with one another or parallel with different instances of the same or similar acts.

As mentioned, FIG. 4 illustrates a flowchart of a series of acts for welding in accordance with one or more embodiments. While FIG. 4 illustrates acts according to one embodiment, alternative embodiments may omit, add to, reorder, and/or modify any of the acts shown in FIG. 4. The acts of FIG. 4 can be performed as part of a method. Alternatively, a computer-readable medium can comprise instructions that, when executed by one or more processors, cause a computing device to perform the acts of FIG. 4. In some embodiments, a system can perform the acts of FIG. 4.

A position controller may position a positive welding electrode and a negative welding electrode with respect to a welding target at 460. A force and position manager may, utilizing force and position sensors, measure force and position of the positive welding electrode and the negative welding electrode at 462. The force and position manager may determine 464 whether the measured force and/or position are within the associated thresholds. If the measured force and/or position are within the threshold, then the force and position manager may continue to monitor the force and position of the welding electrodes.

If the measured force and position are outside of the threshold, then the position controller may cause an electromagnetic actuator to adjust the force and/or position of the associated electrode to be within the threshold at 466. As discussed herein, this may help to improve the quality of the welds formed with the welding system.

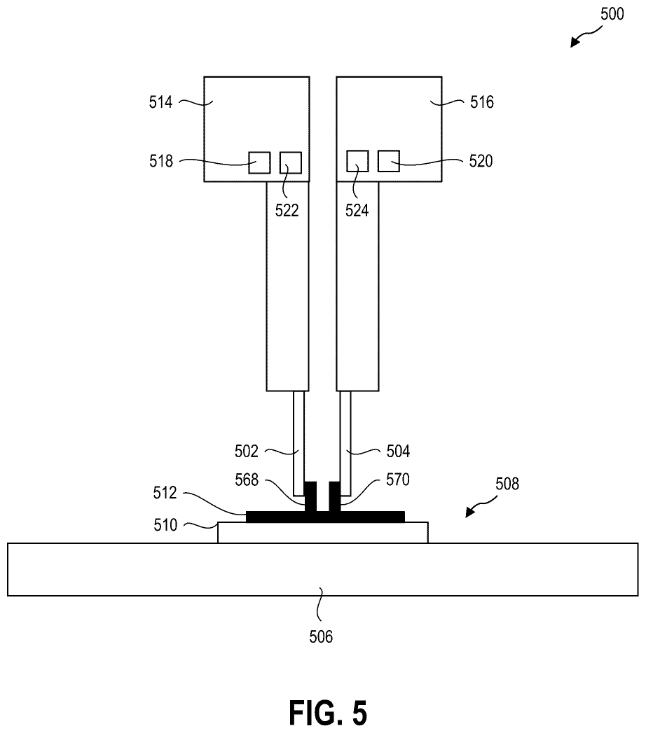

FIG. 5 is a schematic representation of a welding system 500, according to at least one embodiment of the present disclosure. The welding system 500 shown includes a positive electrode 502 and a negative electrode 504. A slide tray 506 supports a welding target 508 having a first material 510 and a second material 512. A positive electromagnetic actuator 514 may position the positive electrode 502 with respect to the welding target 508, such as to place the positive electrode 502 in contact with the second material 512 and apply a force with the positive electrode 502 to the second material 512. A negative electromagnetic actuator 516 may position the negative electrode 504 with respect to the welding target 508, such as to place the negative electrode 504 in contact with the second material 512 and apply a force with the positive electrode 502 to the second material 512.

A positive position sensor 518 may measure a positive position of the positive electrode 502 with respect to the slide tray 506 and/or the welding target 508. A positive force sensor 522 on the positive electrode 502 may measure a positive force of the positive electrode 502 applied to the welding target 508. A negative position sensor 520 on the negative electrode may measure a negative position of the negative electrode 504 with respect to the slide tray 506 and/or the welding target 508. A negative force sensor 524 may measure a negative force of the negative electrode 504 applied to the welding target 508.

In accordance with at least one embodiment of the present disclosure, the positive electrode 502 may include a positive roller 568 and the negative electrode 504 may include a negative roller 570. The current applied to the positive electrode 502 may be passed to the positive roller 568 and into the welding target 508. The current may pass through the welding target 508, into the negative roller 570 and to the negative electrode 504. Resistance from the current in the welding target 508 may cause a weld to form at the welding target 508.

The positive roller 568 and the negative roller 570 may roll along the welding target 508. This may help to weld the second material 512 to the first material 310 along the roll path. For example, the weld current may be pulsed through the positive electrode 502 and the negative electrode 504, resulting in a series of spot welds as the positive roller 568 and the negative roller 570 roll along the welding target 508. In some embodiments, a continuous weld may be generated along the welding target 508.

In accordance with at least one embodiment of the present disclosure, the force and position of the positive roller 568 and the negative roller 570 may be monitored and adjusted based on one or more relevant force and displacement thresholds. For example, the positive position sensor 518 and the positive force sensor 522 may measure the force and position of the positive roller 568 and the negative position sensor 520 and the negative force sensor 524 may measure the force and position of the negative roller 570. A force and position manager may monitor the force and position of the rollers and cause the electromagnetic actuators to adjust the force and position to remain within the relevant thresholds.

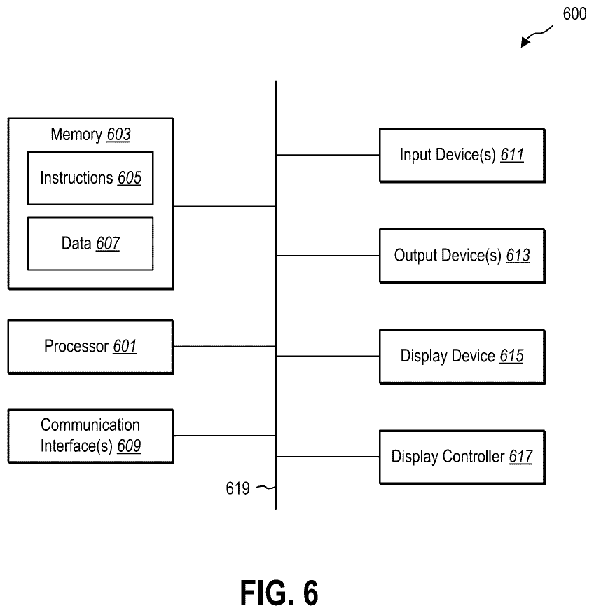

FIG. 6 illustrates certain components that may be included within a computer system 600. One or more computer systems 600 may be used to implement the various devices, components, and systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, controller area network (CAN), RS-232 serial port, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any clement described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A welder, comprising:
a weld head;
a positive welding electrode connected to the weld head;
a positive electromagnetic actuator connected to the positive welding electrode;
a positive position sensor configured to detect a position of the positive welding electrode;
a positive force sensor configured to detect a force applied by the positive welding electrode;
a negative welding electrode connected to the weld head;
a negative electromagnetic actuator connected to the negative welding electrode;
a negative position sensor configured to detect a position of the negative welding electrode; and
a negative force sensor configured to detect a force applied by the negative welding electrode.

2. The welder of claim 1, wherein the positive position sensor and the positive force sensor are located in the positive electromagnetic actuator and wherein the negative position sensor and the negative force sensor are located in the negative electromagnetic actuator.

3. The welder of claim 1, wherein the positive electromagnetic actuator is independently actuatable from the negative electromagnetic actuator.

4. The welder of claim 1, wherein the positive welding electrode is located on the same side of a welding target as the negative welding electrode.

5. The welder of claim 1, wherein the weld head, the positive welding electrode, and the negative welding electrode are configured to generate a weld having a weld size of between 0.1 mm and 0.2 mm.

6. The welder of claim 1, wherein the positive welding electrode includes a positive wheel and the negative welding electrode includes a negative wheel.

7. The welder of claim 6, wherein the positive wheel and the negative wheel are configured to roll along the welding target.

8. A method for welding control, comprising:
positioning, using a plurality of electromagnetic actuators, a positive welding electrode and a negative welding electrode with respect to a welding target;
measuring a positive force and a positive position for the positive welding electrode;
measuring a negative force and a negative position for the negative welding electrode; and
based on at least one of a force difference between the positive force and the negative force or a position difference between the positive position and the negative position, adjusting at least one of a position or a force of the positive welding electrode or the negative welding electrode.

9. The method of claim 8, wherein the plurality of electromagnetic actuators includes a positive electromagnetic actuator connected to the positive welding electrode and a negative electromagnetic actuator connected to the negative welding electrode.

10. The method of claim 8, wherein measuring the positive force, the negative force, the positive position, and the negative position includes measuring the positive force, the negative force, the positive position, and the negative position at the plurality of electromagnetic actuators.

11. The method of claim 8, wherein adjusting the at least one of the position or the force includes adjusting the force of the positive welding electrode or the negative welding electrode until a positive force of the positive welding electrode is approximately equal to a negative force of the negative welding electrode.

12. The method of claim 8, wherein adjusting the at least one of the position or the force includes adjusting the position of the positive welding electrode or the negative welding electrode until a weld displacement is reached.

13. The method of claim 8, wherein positioning the positive welding electrode and the negative welding electrode includes independently positioning the positive welding electrode and the negative welding electrode.

14. The method of claim 8, wherein positioning the positive welding electrode and the negative welding electrode includes positioning the positive welding electrode from a starting positive position and the negative welding electrode from a starting negative position, the starting positive position being different than the starting negative position.

15. A welding system, comprising:
a positive electrode;
a negative electrode;
a positive electromagnetic actuator connected to the positive electrode and including a positive force sensor and a positive position sensor;
a negative electromagnetic actuator connected to the negative electrode and including a negative force sensor and a negative position sensor; and
a processor and memory, the memory including instructions that, when accessed by the processor, cause the processor to:
position, using a plurality of electromagnetic actuators, a positive welding electrode and a negative welding electrode with respect to a welding target;
measure a positive force and a positive position for the positive welding electrode;
measure a negative force and a negative position for the negative welding electrode; and
based on at least one of a force difference between the positive force and the negative force or a position difference between the positive position and the negative position, adjust at least one of a position or a force of the positive welding electrode or the negative welding electrode.

16. The method of claim 15, wherein measuring the positive force, the negative force, the positive position, and the negative position includes measuring the positive force, the negative force, the positive position, and the negative position at the plurality of electromagnetic actuators.

17. The method of claim 15, wherein adjusting the at least one of the position or the force includes adjusting the force of the positive welding electrode or the negative welding electrode until a positive force of the positive welding electrode is approximately equal to a negative force of the negative welding electrode.

18. The method of claim 15, wherein adjusting the at least one of the position or the force includes adjusting the position of the positive welding electrode or the negative welding electrode until a weld displacement is reached.

19. The method of claim 15, wherein positioning the positive welding electrode and the negative welding electrode includes independently positioning the positive welding electrode and the negative welding electrode.

20. The method of claim 15, wherein positioning the positive welding electrode and the negative welding electrode includes positioning the positive welding electrode from a starting positive position and the negative welding electrode from a starting negative position, the starting positive position being different than the starting negative position.
